(19) United States
(12) Patent Application Publication
(10) Pub. No.: US 2026/0099669 A1
(43) Pub. Date: Apr. 9, 2026

(54) DOCUMENT SUMMARIZATION COMPARISON

(71) Applicant: International Business Machines Corporation, Armonk, NY (US)

(72) Inventors: Joseph Kozhaya, Morrisville, NC (US); Andrew R. Freed, Cary, NC (US); Charles E. Beller, Baltimore, MD (US); Donna K. Byron, Petersham, MA (US)

(21) Appl. No.: 18/910,076

(22) Filed: Oct. 9, 2024

(51) Int. Cl. G06F 40/194

(52) U.S. Cl. CPC G06F 40/194

(57) ABSTRACT

Systems and techniques that facilitate comparisons of machine learning model generated summaries are provided. For example, one or more embodiments described herein can comprise a system, which can comprise a memory that can store computer executable components. The system can also comprise a processor, operably coupled to the memory that can execute the computer executable components stored in memory. The computer executable components can comprise an answer component that generates a first answer to a question of a set of questions based on a document, wherein the document is associated with the set of questions and generates a second answer to the question based on a summary document; and a similarity component that updates a similarity score of the document and the summary document, based on a comparison of the first answer to the second answer and a similarity threshold.

### BACKGROUND

The subject disclosure relates to automatic generation of document summarizations, and more specifically, to the directing automatic document summarization based on specific objectives.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate improved automated generation of document summaries are provided.

According to an embodiment, a system can comprise a memory that stores computer executable components; and a processor that executes the computer executable components stored in the memory, wherein the computer executable components comprise: an answer component that generates a first answer to a question of a set of questions based on a document, wherein the document is associated with the set of questions and generates a second answer to the question based on a summary document; and a similarity component that updates a similarity score of the document and the summary document, based on a comparison of the first answer to the second answer and a similarity threshold.

According to another embodiment, a computer-implemented method can comprise generating, by a device operatively couple to a processor, a first answer to a question of a set of questions based on a document, wherein the document is associated with the set of questions; generating, by the device, a second answer to the question based on a summary document; and updating, by the device, a similarity score of the document and the summary document based on a comparison of the first answer to the second answer and a similarity threshold.

According to another embodiment, a computer program product can comprise a computer readable storage medium having program instructions embodied therewith, the program instructions executable by a processor to cause the processor to generate, by the processor, a first answer to a question of a set of questions based on a document, wherein the document is associated with the set of questions; generate, by the processor, a second answer to the question based on a summary document; and update, by the processor, a similarity score of the document and the summary document based on a comparison of the first answer to the second answer and a similarity threshold.

### DESCRIPTION OF THE DRAWINGS

FIGS. 1 and 2 illustrate block diagrams of example, non-limiting, systems that can determine summary accuracy in accordance with one or more embodiments described herein.

FIGS. 3 and 4 illustrate a flow chart of an example, non-limiting, summary comparison method in accordance with one or more embodiments described herein.

FIGS. 5 and 6 illustrate an example of improved summary generation in accordance with one or more embodiments described herein.

FIG. 7 illustrates a flow diagram of an example, non-limiting, computer implemented method that facilitates generation of an answer aggregate document in accordance with one or more embodiments described herein.

FIG. 8 illustrates a flow diagram of an example, non-limiting, computer implemented method that facilitates generation of question sets for document summarization in accordance with one or more embodiments described herein.

FIG. 9 illustrates a flow diagram of an example, non-limiting, computer implemented method that facilitates comparisons of machine generated summaries in accordance with one or more embodiments described herein.

FIG. 10 illustrates an example, a non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As referenced herein, an “entity” can comprise a client, a user, a computing device, a software application, an agent, a machine learning (ML) model, an artificial intelligence (AI) model, and/or another entity.

With the popularization of foundation models, and more specifically, large language models (LLMs), there is increased interest in automated document summarization. The focus is that if LLMs can summarize large text documents effectively, this can help highlight important information and significantly reduce the effort in efficiently disseminating the information within the document. However, this leads to the problem of both how to determine if a document has been accurately summarized by an LLM and which LLM of the increasing number of options should be used to summarize specific documents. For example, a foundation model may not be aware of what information is important for a specific summary. Furthermore, these models may only produce generalized summaries and not those directed to specific objectives.

In view of the problems discussed above, the present disclosure can be implemented to produce a solution to one or more of these problems by generating, by a device operatively couple to a processor, a first answer to a question of a set of questions based on a document, wherein the document is associated with the set of questions; generating, by the device, a second answer to the question based on a summary document; and updating, by the device, a similarity score of the document and the summary document based on a comparison of the first answer to the second answer and a similarity threshold. This enables the comparison of summary to the original document to ensure that the summary contains both the relevant information from the original document, and that the information is accurately represented in the summary document. Furthermore, the set of questions can all be directed to a specific objective, allowing different sets of questions to be used to generate summaries with different objectives from the same document, and without the need to retrain or fine tune the machine learning model.

In one or more embodiments, a further solution to these problems can comprise generating, by the device, an additional answer to the question based on a second summary document; updating, by the device, an additional similarity score of the document and the second summary document based on a comparison of the first answer to the additional answer and the similarity threshold; and selecting, by the device, one of the summary document or the second summary document based on a comparison of the similarity score and the additional similarity score. This enables the comparison of summaries generated by different machine learning models to determine which produces a more accurate summary of the specific document, thereby enabling model selection tailored to the specific document.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

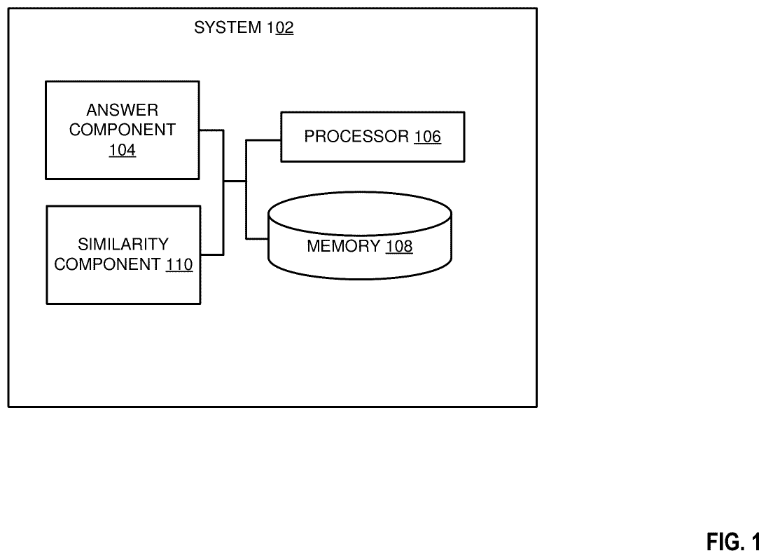

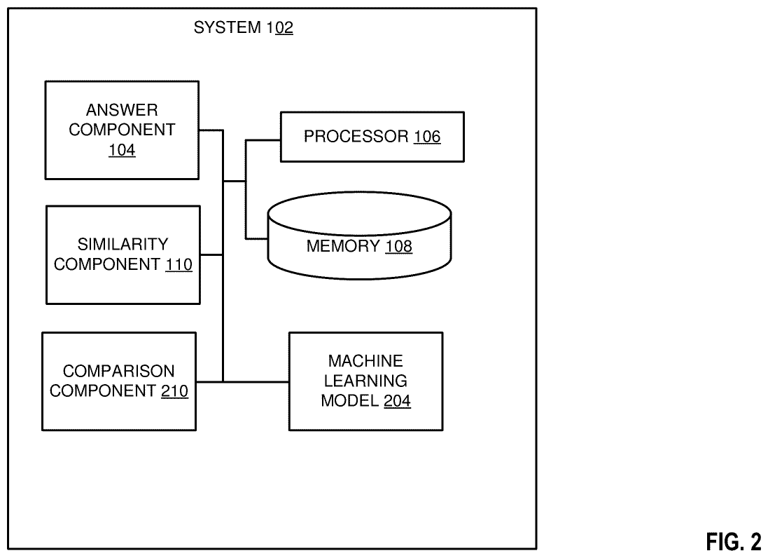

FIGS. 1 and 2 illustrate block diagrams of example, non-limiting use systems 102 and 202 that can facilitate targeted summary generation in accordance with one or more embodiments described herein. Aspects of systems (e.g., systems 102, 202 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise answer component 104, similarity component 110, processor 106 and memory 108. In addition to the elements described in relation to system 102, system 202 can further comprise comparison component 210 and machine learning model 204.

In various embodiments, systems 102 and 202 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the systems 102 and 202 (e.g., answer component 104, similarity component 110, comparison component 210 and/or machine learning model 204) to perform one or more acts. In various embodiments, memory 108 can store computer-executable components (e.g., answer component 104, similarity component 110, comparison component 210 and/or machine learning model 204) and processor 106 can execute the computer-executable components.

In one or more embodiments, answer component 104 can generate an answer to a question of a set of questions based on a document, wherein the document is associated with the set of questions and can generate a second answer to the question based on a summary document. For example, answer component 104 can receive a document, a summary of the document and a set of questions that the summary document should answer. Answer component 104 can then process the document and the summary document for answers for one or more of the questions in the set of questions. The parsing can comprise utilizing keyword searching, sentence match searching, AI answer generation, or another method suitable for searching the document and the summary document for answers. In one or more embodiments, if answer component 104 does not find an answer to a question of the set of questions within the document, the question can be removed from the set of questions as not relevant to the document. This can prevent the summary from being unfairly penalized for lacking information that is not within the original document.

In one or more embodiments, the set of questions can be directed towards specific objectives or purposes of the summary. For example, a first set of questions may be directed to a specific technical portion of the document, while a second set of questions may be directed to a different portion of the document relating to a different subject matter. This enables the comparison between the summary and the document to be tailored to specific use cases or objectives, as opposed to a generalized comparison.

In one or more embodiments, similarity component 110 can update a similarity score of the document and the summary document based on a comparison of the first answer to the second answer and a similarity threshold. For example, similarity component 110 can compare answers from the document and the similarity document to determine if the document accurately answers questions from the set of questions. If the first answer and the second answer are similar enough (e.g., the comparison meets or exceeds a similarity threshold), an overall similarity score of the summary document can be increased by an amount, such as 1. If the first answer and the second answer are not similar enough (e.g., the comparison does not meet the similarity threshold), then the similarity score is not updated and the question is added to a list of unanswered questions. In one or more embodiments, the comparison can comprise matching keywords between the first answer and the second answer, wherein the higher the number of matching keywords, the higher the similarity. In another embodiment, similarity metrics such as Recall-Oriented Understudy for Gisting Evaluation (ROUGE) can be utilized to compare the first answer to the second answer. Use of additional text comparison methods is envisioned.

In one or more embodiments, comparison component 210 can compare the similarity score of the summary document to an overall threshold. For example, once all the answers from the document and the summary document have been compared and the similarity score updated based on the comparisons, comparison component 210 can compare the updated similarity score against an overall threshold. If the similarity score meets or exceeds the overall threshold, then the summary document is deemed to accurately represent the document. If the similarity score does not meet or exceed the threshold, then the list of unanswered questions can serve as an input instruction to machine learning model 204 to generate a new summary document. Further input instructions can comprise information such as summary length, summary format, or other information related to how the summary should be generated. In this manner, the generation of the new summary document can be targeted specifically to information that was found lacking in the original summary document. In one or more embodiments, this process can be repeated multiple times with the new or updated summary document being compared to the original document and multiple iterations of updated summary documents being generated. In one or more embodiments, the set of questions can be related to a specific summarization objective. In this manner multiple sets of questions can be utilized for different types of summarization objectives in order to generate summaries tailored to specific objectives or audiences. For example, even if a summary is deemed accurate to a first set of questions, answer component 104 can collect answers to a second set of questions from the document and the summary, update a second similarity score for the summary, and compare the second updated summary score to the overall threshold to determine if the summary accurately summarizes information related to the second set of questions.

According to some embodiments, machine learning model 204 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, machine learning model 204 can employ principles of probabilistic and decision theoretic inference to determine one or more responses based on information retained in a knowledge source database. In various embodiments, learning model 204 can employ a knowledge source database comprising example summaries and associated original documents. Additionally, or alternatively, learning model 204 can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive a conclusion as to a response to a question.

As used herein, the term “inference” refers generally to the process of reasoning about or inferring states of the system, a component, a module, the environment, and/or assessments from one or more observations captured through events, reports, data, and/or through other forms of communication. Inference can be employed to identify a specific context or action, or can generate a probability distribution over states, for example. The inference can be probabilistic. For example, computation of a probability distribution over states of interest can be based on a consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects. Furthermore, the inference processes can be based on stochastic or deterministic methods, such as random sampling, Monte Carlo Tree Search, and so on.

The various aspects can employ various artificial intelligence-based schemes for carrying out various aspects thereof. For example, a process for determining text segmentation boundaries, text capitalization and punctuation, without interaction from the target entity, which can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to prognose or infer an action that should be employed to make a determination. The determination can include, but is not limited to, what to include in a document summary, the format of the summary, or an answer to a question located within a document of summary.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, SVM's can be configured through a learning phase or a training phase within a classifier constructor and feature selection module. Thus, a classifier(s) can be used to automatically learn and perform a number of functions, including but not limited to classification of document summary, the format of the summary, or an answer to a question located within a document of summary. Furthermore, one or more aspects can employ machine learning models that are trained utilizing reinforcement learning. For example, penalty/reward scores can be assigned for various outputs generated by machine learning model 204 based on defined entity preferences. Accordingly, machine learning model 204 can learn via selecting options with lower penalties and/or higher rewards in order to reduce an overall penalty score and/or increase an overall reward score.

In one or more embodiments, summaries generated by different machine learning models can also be compared. For example, after determining a similarity score for a first summary document as described above, answer component 104 can generate additional answers to the set of questions using a second summary document. The similarity component 110 can then update an additional similarity score for the second summary document as described above. The similarity score of the summary document and the additional similarity score of the second summary document can be compared, wherein the summary document with the higher score is selected. In some embodiments, this can be utilized to compare the performance of different machine learning models producing summaries. For example, the first summary can be generated using a first machine learning model and the second summary can be generated using a second machine learning model. Based on the comparison of the similarity scores of the summary documents, a determination of which machine learning model produces more accurate summaries can be made.

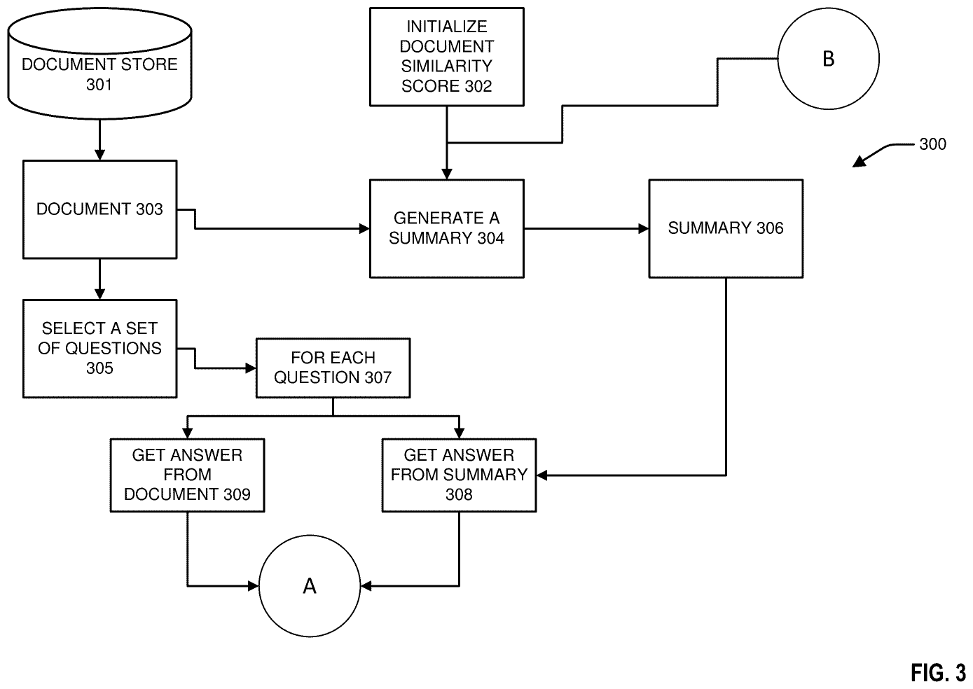

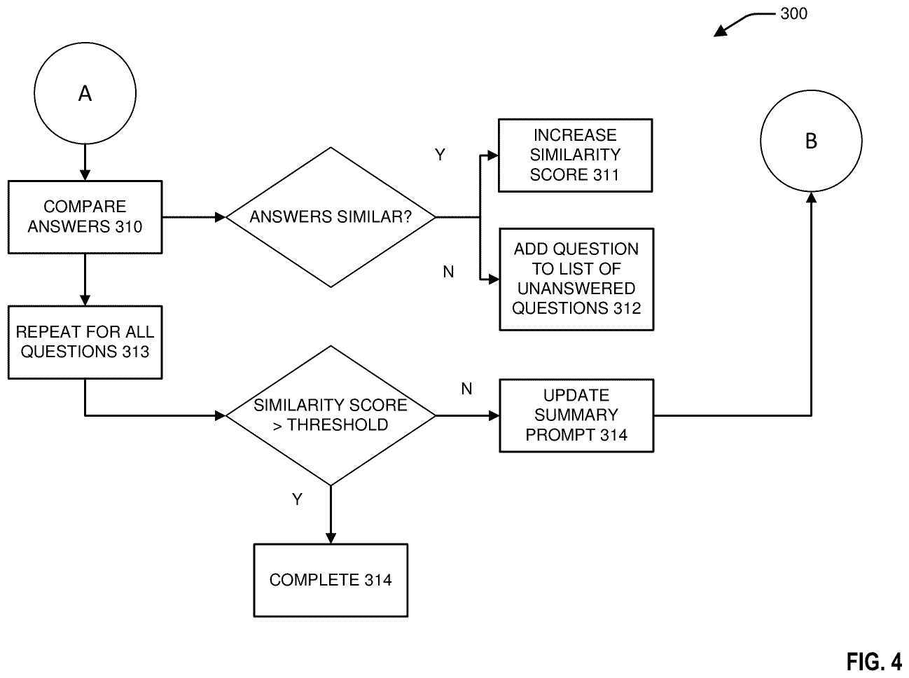

FIGS. 3 and 4 illustrate a flow chart 300 of an example, non-limiting, summary comparison method in accordance with one or more embodiments described herein.

At 301 a document 303 is pulled from a document store. At 302 a document similarity score is initialized and then document 303 is used by a machine learning model at 304 to generate summary 306. At 305 a set of questions related to the document 303 is selected. This set of questions can be selected from multiple possible sets of questions and can be directed towards a specific summarization objective. At 307, for each question within the set of questions, an answer can be pulled from the document at 309 and from the summary at 308. Turing to FIG. 4, at 310 the answers are compared using a similarity metric. If the answers are determined to be similar (e.g., the similarity metric is greater than or equal to the similarity metric) then the similarity score can be increased at step 311. If the answer is determined to not be similar, then the question can be added to a list of unanswered questions at 312. This is then repeated for all questions at 313. Then the updated similarity score is compared to an overall threshold. If the similarity score is greater than the threshold, then the summary is accurate to the document and the summary generation is complete at 314. If the similarity score is not greater than the threshold, then a summary generation prompt 314 can be updated with the list of unanswered questions. The method can then return to step 304 and generate an updated summary using the updated summary prompt.

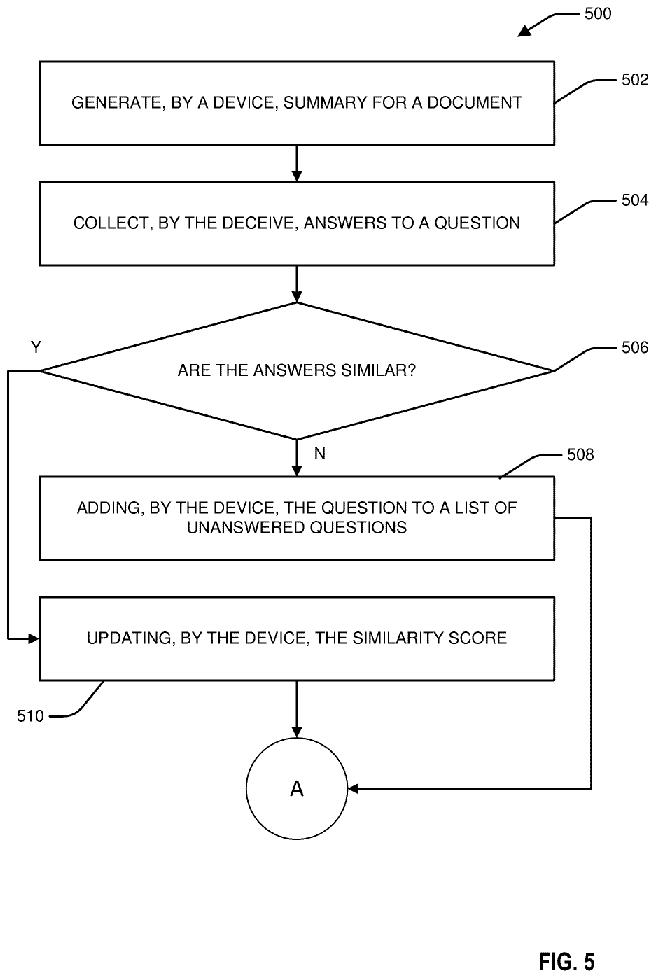

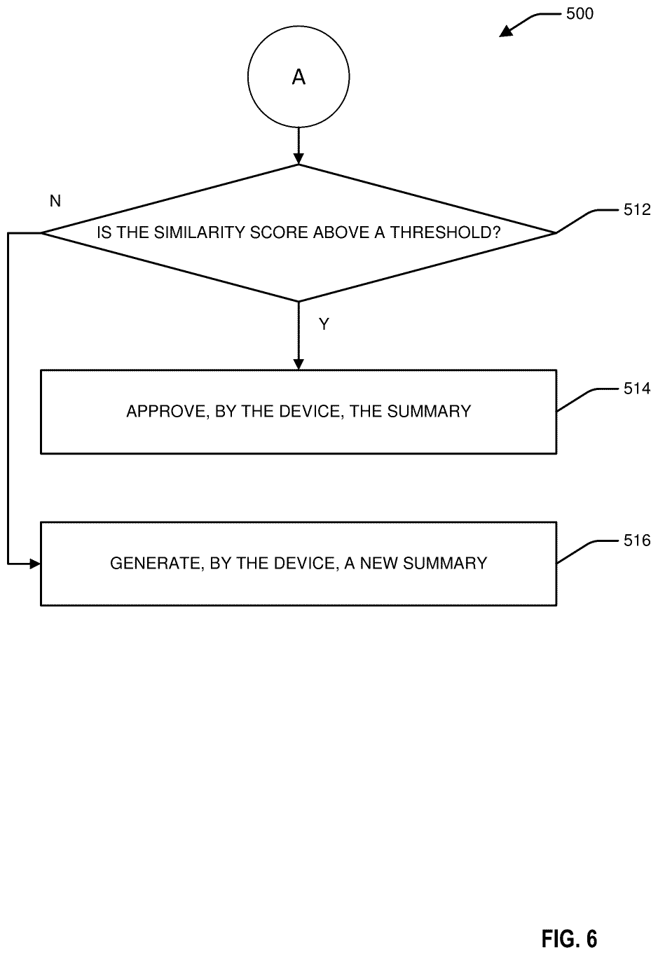

FIGS. 5 and 6 illustrate an example of improved summary generation in accordance with one or more embodiments described herein. Repetitive description of like elements employed in other embodiments described herein is omitted for sake of brevity.

At 502, method 500 can comprise generating, by a device (e.g., systems 102, 202 and/or machine learning model 204) operatively coupled to a processor (e.g., processor 106), a summary for a document. For example, as described above in reference to FIGS. 1 and 2, machine learning model 204 can comprise a generative AI model that takes the document as an input and generates a summary document. After the summary has been generated, a similarity score for the summary can be initialized and set to zero.

At 504, method 500 can comprise collecting, by the system (e.g., systems 102, 202 and/or answer component 104), answers to a question. For example, for each question in a set of questions associated with the document, answer component 104 can scrape the document for a first answer and the summary document for a second answer to the question. If the document lacks information for the answer component to generate a first answer, the question can be removed from the list of questions.

At 506, method 500 can comprise comparing, by the device (e.g., systems 102, 202 and/or similarity component 110), if the answers from the document are similar to the answers from the summary document. For example, in an embodiment, a number of matching keywords between the document answer and the summary answer can be used to determine similarity. In another embodiment, a text similarity metric such as ROUGE can be used to compare the answers. If the similarity meets or exceeds a defined threshold (e.g., a YES determination), then method 500 can proceed to step 510. If the similarity does not meet or exceed the defined threshold (e.g., a NO determination), then method 500 can proceed to step 508. In one or more embodiments, step 506 can be repeated for all questions within the set of questions.

At 508, method 500 can comprise adding, by the device (e.g., systems 102, 202 and/or similarity component 110) one or more questions that the summary document did not answer accurately can be added to a list of unanswered questions.

At 510, method 500 can comprise updating, by the device (e.g., systems 102, 202 and/or similarity component 110) the similarity score for the summary document. For example, for each answer from the summary document that was deemed accurate (e.g., those with a similarity that exceed the defined threshold), the similarity score for the summary document can be increased by 1.

At 512, method 500 can comprise comparing, by the device (e.g., systems 102, 202 and/or comparison component 210), the similarity score to an overall similarity threshold. If the similarity score meets or exceeds the threshold (e.g., a YES determination), then the summary document is an accurate summary of the original document and can be approved at step 514. If the similarity score does not meet the threshold (e.g., a NO determination), then the summary document is not an accurate summary of the original document and method 500 can proceed to step 516 to generate a new summary using machine learning model 204. As part of this generation, the list of unanswered questions from step 508 can be utilized as a generation input to ensure that the updated summary document comprises the information missing from the original summary document.

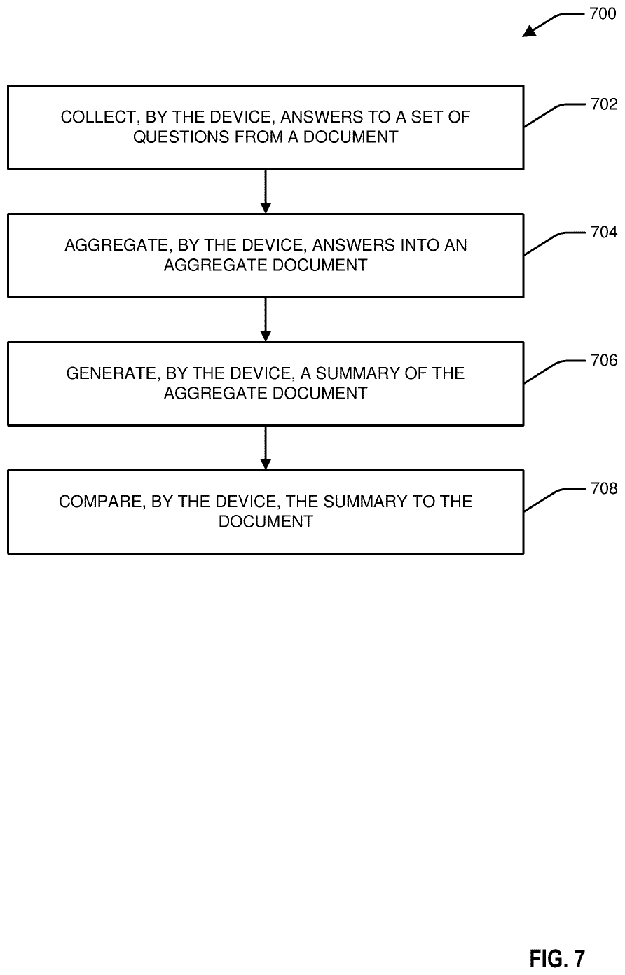

FIG. 7 illustrates a flow diagram of an example, non-limiting, computer implemented method 700 that facilitates generation of an answer aggregate document in accordance with one or more embodiments described herein.

At 702, method 700 can comprise collecting, by a device (e.g., systems 102, 202 and/or answer component 104) operatively coupled to a processor (e.g., processor 106), answers to a set of questions from a document. For example, for each question in a set of questions associated with the document, answer component 104 can scrape the document for answers to the questions.

At 704, method 700 can comprise aggregating, by the device (e.g., systems 102, 202 and/or answer component 104), the answers into an aggregated document. For example, the aggregate document can comprise the answers to the questions without extraneous information from the document.

At 706, method 700 can comprise generating, by a device (e.g., systems 102, 202 and/or machine learning model 204) a summary document from the aggregate document. As the aggregate document has been limited in its content, this can prevent the machine learning model from including extraneous information in the summary.

At 708, method 700 can comprise comparing, by the device (e.g., systems 102 and 202) the summary to the document. For example, the summary document can be compared to the original document in the manner illustrated in steps 504-516 of method 500.

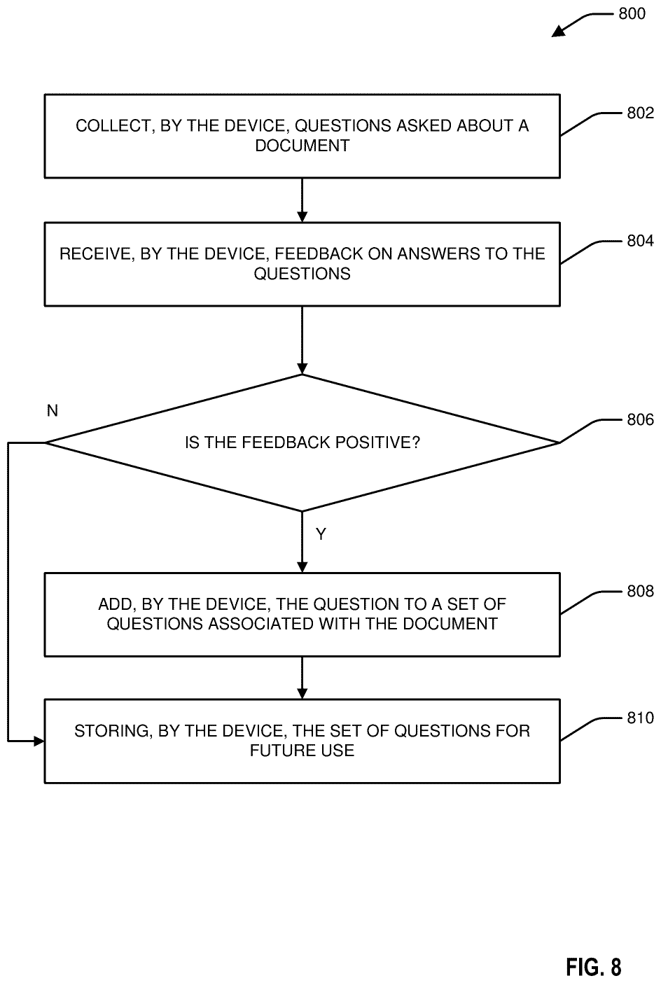

FIG. 8 illustrates a flow diagram of an example, non-limiting, computer implemented method 800 that facilitates generation of question sets for document summarization in accordance with one or more embodiments described herein.

At 802, method 800 can comprise collecting, by a device (e.g., systems 102 and 202) operatively coupled to a processor (e.g., processor 106), questions asked about a document by one or more entities. For example, an entity can ask questions related to a document, using a machine learning model or another text search function that outputs the answers found within the document.

At 804, method 800 can comprise receiving, by the device (e.g., systems 102 and 202), feedback on answers to the questions. For example, after an answer is output to an entity, the entity can be requested to provide feedback on whether the answer was helpful or not. This feedback can be collected for multiple entities based on similar questions asked by the multiple entities.

At 806, method 800 can comprise determining, by the device (e.g., systems 102 and 202), if the feedback to the answer was positive. For example, if the number of positive feedback responses to an answer is greater than or equal to a threshold (e.g., a YES determination), then the feedback is considered positive overall and method 800 can proceed to step 808. If the number of positive feedback responses to an answer is less than the threshold (e.g., a NO determination), then method 800 can proceed to step 810.

At 808, method 800 can comprise adding, by the device (e.g., systems 102 and 202), the question to a set of questions associated with the document. For example, if the feedback to an answer is determined to be positive in step 806, the question associated with the answer can be added to a set of questions associated with the document.

At 810, method 800 can comprise storing, by the device (e.g., systems 102 and 202), the set of questions for future use. For example, the set of questions can be stored for future use as part of summary generation as described above in reference to FIGS. 1-6.

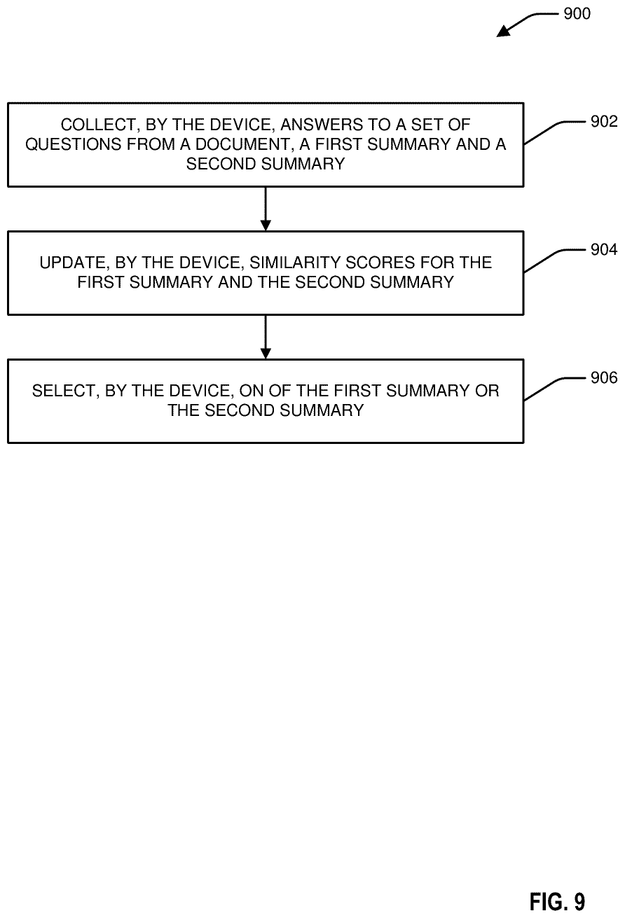

FIG. 9 illustrates a flow diagram of an example, non-limiting, computer implemented method 900 that facilitates comparisons of machine generated summaries in accordance with one or more embodiments described herein.

At 902, method 900 can comprise collecting, by a device (e.g., systems 102, 202 and/or answer component 104) operatively coupled to a processor (e.g., processor 106), answers to a set of questions from a document a first summary of the document and a second summary of the document. For example, a first machine learning model can be utilized to generate the first summary and a second machine learning model can be utilized to generate a second summary. Answer component 104 can then scrape the original document, the first summary and the second summary for answers to questions as described above in relation to FIGS. 1-2.

At 904, method 900 can comprise updating, by the device (e.g., systems 102, 202 and/or similarity component 110) similarity scores for the first summary and the second summary. For example, the summary scores can be updated as described above in reference to FIGS. 1-2.

At 906, method 900 can comprise selecting, by the device (e.g., systems 102 and 202) one of the first summary or the second summary based on a comparison of the respective similarity scores. For example, the summary with the highest similarity score can be selected.

In this manner, the device enables a direct comparison of summaries generated by different machine learning models, enabling comparisons of performance of the different models.

A practical application of systems 102 and 202 is that they enable evaluation of machine generated summaries, specialized based on the document being summarized. As described above, machine learning models are broadly trained to generate summaries, and thus may not capture the nuance or importance of specific pieces of data within a document. Accordingly, the systems and methods described herein allow for comparisons between the original document and the summary to determine if the summary accurately captures the data relevant to the summary. A further practical application of systems 102 and 202 is that they enable direct comparisons of summaries generated using different machine learning models. Due to the prevalence of machine learning models, it may be difficult to determine which machine learning model produces more accurate summaries of specific documents of types of documents. Accordingly, by comparing the summaries first to the original document, and then to each other, a determination can be made as to which summary, and thus which machine learning model, better captures the document in question. This enables more efficient dissemination of information.

It is to be appreciated that systems 102 and 202 can utilize various combination of electrical components, mechanical components, and circuity that cannot be replicated in the mind of a human or performed by a human as the various operations that can be executed by systems 102 and 202 and/or components thereof as described herein are operations that are greater than the capability of a human mind. For instance, the amount of data processed, the speed of processing such data, or the types of data processed by systems 102 and 202 over a certain period of time can be greater, faster, or different than the amount, speed, or data type that can be processed by a human mind over the same period of time. According to several embodiments, systems 102 and 202 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that systems 102 and 202 can include information that is impossible to obtain manually by an entity, such as a human user. For example, the type, amount, and/or variety of information included in systems 102 and 202 can be more complex than information obtained manually by an entity, such as a human user.

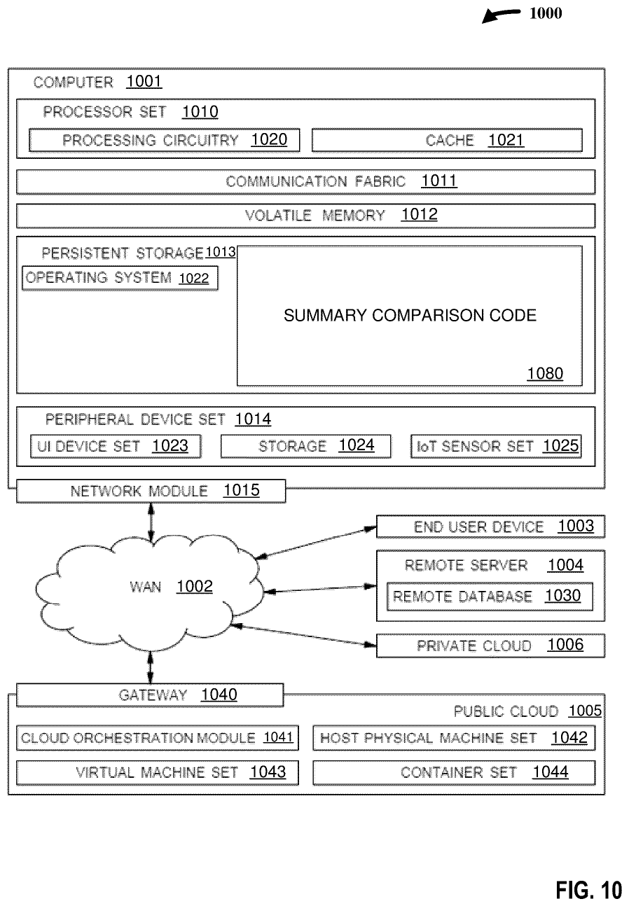

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the summary comparison code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip.” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising: a memory that stores computer executable components; and a processor that executes the computer executable components stored in the memory, wherein the computer executable components comprise:
an answer component that generates a first answer to a question of a set of questions based on a document, wherein the document is associated with the set of questions and generates a second answer to the question based on a summary document; and
a similarity component that updates a similarity score of the document and the summary document, based on a comparison of the first answer to the second answer and a similarity threshold.

2. The system of claim 1, wherein the updating the similarity score comprises:
adding to the similarity score based on a determination that similarity of the first answer and the second answer exceeds the similarity threshold; and
adding the question to a list of unanswered questions based on a determination that the similarity of the first answer and the second answer does not exceed the similarity threshold.

3. The system of claim 2, wherein the computer executable components further comprise:
a comparison component that compares the similarity score to an overall score threshold; and
a machine learning model that, in response to a determination that the similarity score is below the overall score threshold, generates an updated document summary from the document, wherein the list of unanswered questions serves as an input instruction for the machine learning model.

4. The system of claim 3, wherein the summary document is generated by the machine learning model.

5. The system of claim 1, wherein the answer component further generates a third answer to a question of a second set of questions based on the document, wherein the document is associated with the second set of questions and wherein the set of questions and the second set of questions are related to different summarization objectives and generates a fourth answer to the question based on the summary document; and wherein the similarity component updates a second similarity score of the document and the summary document based on a comparison of the third answer to the fourth answer and the similarity threshold.

6. The system of claim 1, wherein the computer executable components further comprise a proofing component that checks if an answer to the question of the set of questions exists within the document and in response to a determination that the answer to the question does not exist within the document, removes the question from the set of questions.

7. A computer implemented method comprising:
generating, by a device operatively couple to a processor, a first answer to a question of a set of questions based on a document, wherein the document is associated with the set of questions;
generating, by the device, a second answer to the question based on a summary document; and
updating, by the device, a similarity score of the document and the summary document based on a comparison of the first answer to the second answer and a similarity threshold.

8. The computer implemented method of claim 7, wherein the updating the similarity score comprises:
adding, by the device, to the similarity score based on a determination that similarity of the first answer and the second answer exceeds the similarity threshold; and
adding, by the device, the question to a list of unanswered questions based on a determination that the similarity of the first answer and the second answer does not exceed the similarity threshold.

9. The computer implemented method of claim 8, further comprising:
comparing, by the device, the similarity score to an overall score threshold; and
in response to a determination that the similarity score is below the overall score threshold, generating, by a machine learning model, an updated document summary from the document, wherein the list of unanswered questions serves as an input instruction of a one or more of input instructions for the machine learning model.

10. The computer implemented method of claim 7, wherein the summary document is generated by a machine learning model.

11. The computer implemented method of claim 7, further comprising:
generating, by the device, a third answer to a question of a second set of questions based on the document, wherein the document is associated with the second set of questions and wherein the set of questions and the second set of questions are related to different summarization objectives;
generating, by the device, a fourth answer to the question based on the summary document; and
updating, by the device, a second similarity score of the document and the summary document based on a comparison of the third answer to the fourth answer and the similarity threshold.

12. The computer implemented method of claim 7, further comprising:
checking, by the device, if an answer to the question of the set of questions exists within the document; and
in response to a determination that the answer to the question does not exist within the document, removing, by the device, the question from the set of questions.

13. The computer implemented method of claim 7, further comprising:
generating, by the device, an additional answer to the question based on a second summary document;
updating, by the device, an additional similarity score of the document and the second summary document based on a comparison of the first answer to the additional answer and the similarity threshold; and
selecting, by the device, one of the summary document or the second summary document based on a comparison of the similarity score and the additional similarity score.

14. A computer program product comprising a non-transitory computer-readable memory having program instruction embodied therewith, the program instructions executable by a processor to cause the processor to:
generate, by the processor, a first answer to a question of a set of questions based on a document, wherein the document is associated with the set of questions;
generate, by the processor, a second answer to the question based on a summary document; and
update, by the processor, a similarity score of the document and the summary document based on a comparison of the first answer to the second answer and a similarity threshold.

15. The computer program product of claim 14, wherein the updating the similarity score comprises:
adding, by the processor, to the similarity score based on a determination that similarity of the first answer and the second answer exceeds the similarity threshold; and
adding, by the processor, the question to a list of unanswered questions based on a determination that the similarity of the first answer and the second answer does not exceed the similarity threshold.

16. The computer program product of claim 15, wherein the program instructions are further executable by the processor to cause the processor to:
compare, by the processor, the similarity score to an overall score threshold; and
in response to a determination that the similarity score is below the overall score threshold, generate, by a machine learning model, an updated document summary from the document, wherein the list of unanswered questions serves as an input instruction for the machine learning model.

17. The computer program product of claim 14, wherein the summary document is generated by a machine learning model.

18. The computer program product of claim 14, wherein the program instructions are further executable by the processor to cause the processor to:
generate, by the processor, a third answer to a question of a second set of questions based on the document, wherein the document is associated with the second set of questions and wherein the set of questions and the second set of questions are related to different summarization objectives;
generate, by the processor, a fourth answer to the question based on the summary document; and
update, by the processor, a second similarity score of the document and the summary document based on a comparison of the third answer to the fourth answer and the similarity threshold.

19. The computer program product of claim 14, wherein the program instructions are further executable by the processor to cause the processor to:
check, by the processor, if an answer to the question of the set of questions exists within the document; and
in response to a determination that the answer to the question does not exist within the document, remove, by the processor, the question from the set of questions.

20. The computer program product of claim 14, wherein the program instructions are further executable by the processor to cause the processor to:
generate, by the processor, an additional answer to the question based on a second summary document;
update, by the processor, an additional similarity score of the document and the second summary document based on a comparison of the first answer to the additional answer and the similarity threshold; and
select, by the processor, one of the summary document or the second summary document based on a comparison of the similarity score and the additional similarity score.
